(19) United States
(12) Patent Application Publication
(10) Pub. No.: US 2020/0121011 A1
(43) Pub. Date: Apr. 23, 2020

(54) Decorative Patch Kit and Method

(71) Applicants: Emma Williams, Santa Monica, CA (US); Tanner Bloom, Santa Monica, CA (US)

(72) Inventors: Emma Williams, Santa Monica, CA (US); Tanner Bloom, Santa Monica, CA (US)

(21) Appl. No.: 16/165,969

(22) Filed: Oct. 19, 2018

(51) Int. Cl. A41D 27/08; B44C 1/10

(52) U.S. Cl. CPC A41D 27/08; B44C 1/105

(57) ABSTRACT

A decorative patch kit and method is provided which enables a user to temporarily and permanently adhere such decorative patch to a desirable receiving surface. The kit comprises an ornamental member and at least one temporary adhesive member. Providing a decorative patch kit comprising an ornamental member defined by a textile surface and a backing surface coated with a thermoplastic, heat-activated adhesive material; joining the temporary adhesive member with the ornamental member, thereby forming a temporary patch assembly; affixing the temporary patch assembly to the desirable receiving surface; removing the temporary patch assembly from the desirable receiving surface; removing the temporary adhesive member from the ornamental member; placing the backing surface of the ornamental member along the same or a different desirable receiving surface; and then applying heat to the ornamental member, in accordance with embodiments of the method, may allow versatility in application of the decorative patch and further allow consumers to vary application of the temporary patch.

### GOVERNMENT CONTRACT

Not applicable.

### CROSS-REFERENCE TO RELATED APPLICATIONS

Not applicable.

### STATEMENT RE. FEDERALLY SPONSORED RESEARCH/DEVELOPMENT

Not applicable.

### COPYRIGHT & TRADEMARK NOTICES

A portion of the disclosure of this patent document may contain material which is subject to copyright protection. This patent document may show and/or describe matter which is or may become trade dress of the owner. The copyright and trade dress owner has no objection to the facsimile reproduction by any one of the patent document or the patent disclosure, as it appears in the Patent and Trademark Office patent files or records, but otherwise reserves all copyrights and trade dress rights whatsoever.

### TECHNICAL FIELD

The disclosed subject matter relates generally to decorative patches and, more particularly, to a decorative patch kit and method for temporarily and permanently adhering the same to a desirable receiving surface.

### BACKGROUND

Heat activated decorative patches are well known and serve a variety of purposes. For instance, decorative patches can provide numerals on sports jerseys, company logos and employee names on uniforms, or even a labeling system for distinguishing between articles of clothing. In another instance, such patches can represent achievement such as merit badges on a wilderness group's vests. Most often, people desire to adorn their bodies and accessories with ornamental designs that represent their individuality and personal causes or interests they support. Decorative patches can also serve the dual purpose of being both ornamental and functional. In particular, decorative patches can be used to cover holes or torn portions of clothing. U.S. Pat. No. 6,038,702 to Knerr discloses a patch comprised of two die cut pieces of ornamented material with an aperture in the center to decorate and reinforce a hole that has already formed in clothing or fabric.

Pressure-sensitive adhesive patches or stickers are similarly well known and can provide both aesthetic and functional appeal. By way of example, pressure-sensitive adhesive stickers are commonly used to label prices and price markdowns in retail stores. These stickers also allow consumers to temporarily embellish their personal property. For instance, U.S. patent application Ser. No. 10/746,842 provides a decorative adhesive article and method for applying the same to an electronic device, namely, a cellular phone.

Limitations in application constitute a primary drawback of both heat-activated and pressure-sensitive adhesive patches. In particular, heat-activated patches are unable to adhere to many items such as waterproof materials, including rainwear. Moreover, heat-activated patches cannot be utilized on plastic, nylon, highly elastic, tri-acetate fabrics, leather, silk or other delicate fabrics as these materials are known to melt upon the application of intense heat necessary to affix the heat-activated patch. Often, these patches are limited to application on polyester and cotton fabrics. Further, heat-activated patches are permanent once bonded to a surface. This deprives wearers of the ability to change their mind or to later reapply the patch to a different surface. There exists a need for a decorative patch that can temporarily affix to a greater variety of surfaces.

To the contrary, pressure-sensitive stickers are not tacky enough to adhere to every surface. Typically, pressure-sensitive adhesive stickers bond only to substantially smooth, flat surfaces. Moreover, some pressure-sensitive stickers are solely decorative while others are solely medical grade. Often, individuals desiring to adorn their skin with decorative articles are unable to do so because the type of adhesive used is not medical grade and may cause skin irritation or rash. Likewise, while medical grade adhesive stickers are effective at helping to deliver transdermal medicine and binding injured bones or muscles, these are often aesthetical banal or displeasing. As a result, there is a need for the ability to decorative one's skin with ornamental patches that are medically safe and potentially, medically beneficial.

Additionally, these patches are often temporary in their ability to adhere to a surface. Users often have to deal with the edges of such stickers peeling up under hot or humid conditions. On the other hand, under cold or dry conditions, these stickers are prone to cracking or otherwise losing their aesthetic attractiveness. Even under normal or ideal conditions, individuals may desire for their temporary decorative stickers to become permanent. There is a need for decorative patches which can be applied temporarily and then, if the individual so desires, permanently.

### SUMMARY

The present disclosure is directed to a decorative patch kit and method for adhering the decorative patch temporarily and permanently to a desirable receiving surface.

For purposes of summarizing, certain aspects, advantages, and novel features have been described. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested.

In accordance with one embodiment, the decorative patch kit may comprise an ornamental member and at least one temporary adhesive member. The ornamental member may be configured to affix to the temporary adhesive member and temporarily adhere to a desirable receiving surface and also permanently adhere to the same or a different desirable receiving surface.

The ornamental member may be defined by a textile surface and a backing surface. The textile surface may further comprise one or more decorative elements such as sequins, embroidery, glitter, or fabric. The backing surface may support the textile surface and may receive the temporary adhesive member for temporary adhesion. The backing surface may comprise a blend of one or more synthetic, semi-synthetic, or natural elements or materials. In some embodiments, the backing surface may comprise a thermoplastic, heat-sensitive material or an adhesive material, which may allow the ornamental member to temporarily or permanently adhere to a desirable receiving surface without the use of the temporary adhesive member or any other temporary or permanent adhesive agent.

According to certain embodiments, the ornamental member may affix to the temporary adhesive member. The temporary adhesive member may be defined by a first surface and a second surface. Each of the first and second surfaces may be coated with a pressure-sensitive, adhesive material. A first release liner may peelably attach to the first surface and a second release liner may peelably attach to the second surface. Each of the first and second release liners may be formed out of a release coating and may protect and maintain the adhesive characteristics of the first and second surfaces.

An exemplary method for applying the decorative patch kit temporarily and then permanently to a desirable receiving surface may comprise the following, exemplary steps. If necessary, an outline around the ornamental member may be traced along and cut out of the first release liner of the temporary adhesive member. The first release liner may then be peeled off the first surface and the backing surface of the ornamental member may be affixed to the first surface, forming a temporary patch assembly. The second release liner may be peeled off the second surface. The temporary patch assembly may then be adhered to a desirable receiving surface.

In certain embodiments, more than one temporary adhesive member may be supplied so as to allow multiple applications of the temporary patch assembly by repeating the above steps. In other embodiments, the backing surface of the ornamental member may be formed out of an adhesive material and may be directly adhered to a desirable receiving surface.

The temporary patch assembly may be removed from the selected receiving surface. In some embodiments, the temporary adhesive member may remain on the backing surface of the ornamental member. In other embodiments, the temporary adhesive member may be removed from the backing surface of the ornamental member by peeling or rubbing, for example. The backing surface of the ornamental member may be formed out of a thermoplastic, heat-activated adhesive material. The same or a different desirable receiving surface may be laid flat on a stable surface and the backing surface of the ornamental member may be placed along the selected receiving surface. A protective fabric may be placed on top of the textile surface of the ornamental member so as to protect the one or more design elements thereon.

Next, heat may be applied to the protective fabric. In certain embodiments, heat is applied for thirty to forty-five seconds. The permanent patch assembly may then be allowed to cool. The permanent patch assembly may be turned over such that the underside of the selected receiving surface may serve the same purpose as the protective fabric before. Heat may then be applied again. In some embodiments, heat is applied for thirty to forty-five seconds. As before, the permanently patch assembly may then be allowed to cool.

One or more of the above-disclosed embodiments, in addition to certain alternatives, are provided in further detail below with reference to the attached figures. The disclosed subject matter is not, however, limited to any particular embodiment disclosed.

### BRIEF DESCRIPTION OF THE DRAWINGS

FIG. 1 shows elements comprising a decorative patch kit in accordance with one embodiment of the invention.

FIG. 2 shows a flowchart of an exemplary method of this invention.

FIG. 3 shows a cross-sectional view of an ornamental member.

FIG. 4 shows a cross-sectional view of a temporary adhesive member.

FIG. 5 shows a perspective view of a temporary adhesive member in accordance with one embodiment of the invention.

FIG. 6 shows a flowchart of an exemplary method of this invention.

The disclosed embodiments may be better understood by referring to the figures in the attached drawings, as provided below. The attached figures are provided as non-limiting examples for providing an enabling description of the method and system claimed. Attention is called to the fact, however, that the appended drawings illustrate only typical embodiments of this invention and are therefore not to be considered as limiting of its scope. One skilled in the art will understand that the invention may be practiced without some of the details included in order to provide a thorough enabling description of such embodiments. Well-known structures and functions have not been shown or described in detail to avoid unnecessarily obscuring the description of the embodiments.

### DETAILED DESCRIPTION

Having summarized various aspects of the present disclosure, reference will now be made in detail to that which is illustrated in the drawings. While the disclosure will be described in connection with these drawings, there is no intent to limit it to the embodiment or embodiments disclosed herein. Rather, the intent is to cover all alternatives, modifications and equivalents included within the spirit and scope of the disclosure as defined by the appended claims.

A kit and method for applying a decorative patch to a selected desirable receiving surface are provided that, in some embodiments, permit users to temporarily adhere and subsequently permanently adhere a decorative patch so as to allow users versatility of application.

In some embodiments, one embodiment of a decorative patch kit may comprise an ornamental member and at least one temporary adhesive member in order to provide a temporary adhesive patch, as well as, a permanent adhesive patch. For purposes of brevity, a decorative patch kit featuring an ornamental member shaped as an ice cream cone is shown and described, however, it will be understood that various styles of decorative patch kits may be adapted according to this disclosure to allow both temporary and permanent adhesion to a desired surface.

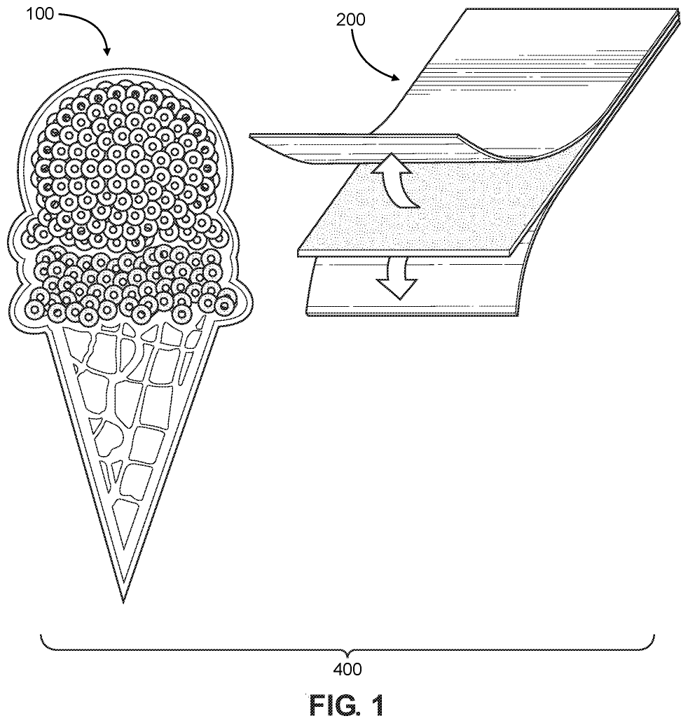

A description of one embodiment of a kit and method for temporarily and permanently applying a decorative patch is now described followed by a discussion of the operation of various components within the kit. In this regard, FIG. 1 illustrates an exemplary embodiment of a decorative patch kit 400.

More particularly, FIG. 1 illustrates an exemplary embodiment of the decorative patch kit 400 comprising an ornamental member 100 and a temporary adhesive member 200. The ornamental member 100 may add aesthetic value to the decorative patch kit 400 while the temporary adhesive member 200 may provide a means to adhere the ornamental member 100 to a desirable receiving surface.

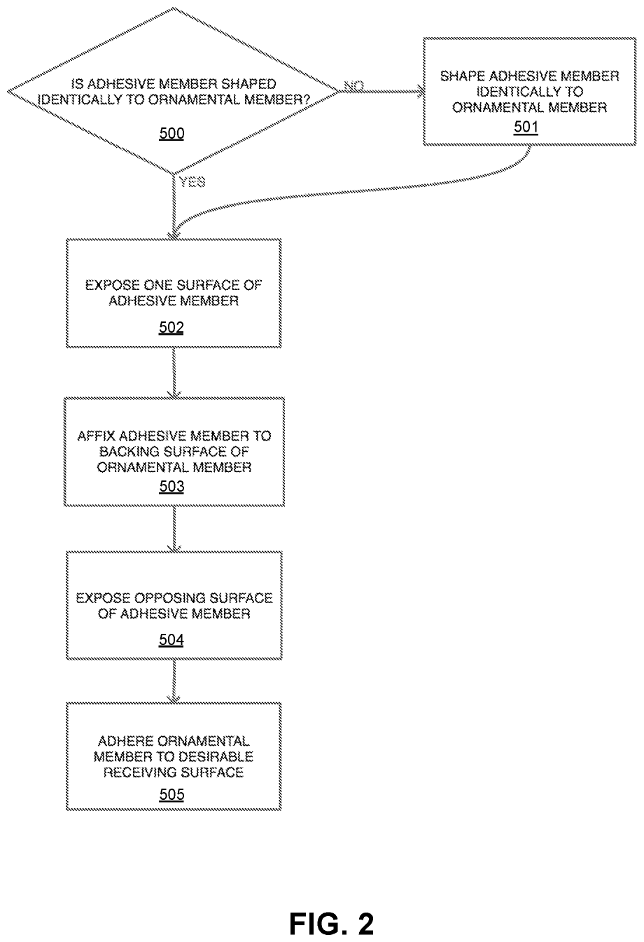

FIG. 2 is a flowchart depicting an exemplary embodiment of a method for temporarily or permanently applying a decorative patch such as may be performed by the decorative patch kit 400 of FIG. 1. As shown in FIG. 2, method may include the following exemplary steps. First, if necessary, the temporary adhesive member may be shaped identically to the ornamental member (block 501). Next, one surface of the adhesive member may be exposed and may then be affixed to a backing surface of the ornamental member (blocks 502 and 503). An opposing surface may then be exposed and the ornamental member may then be adhered to a desirable receiving surface (blocks 504 and 505).

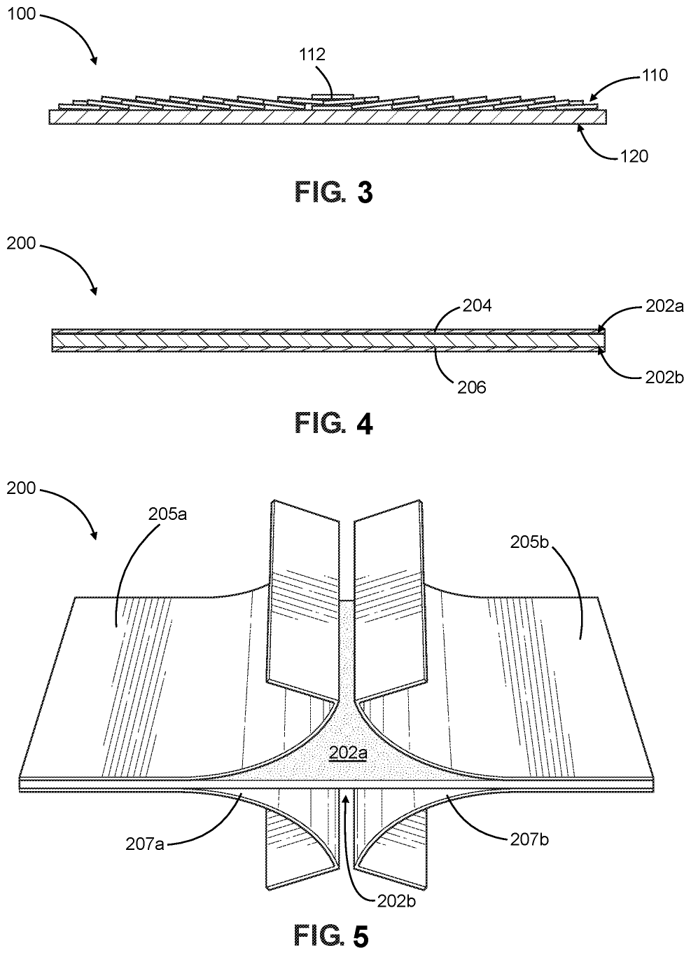

FIG. 3 illustrates an ornamental member 100 shown in FIG. 1. The ornamental member may comprise a textile surface 110 and a backing surface 120 opposing the textile surface 110. The textile surface 110 may be die cut or otherwise formed into any desired shape and may further comprise one or more design elements 112. The design elements 112 may be securably joined to the textile surface 110 using any appropriate securing means such as, for instance, thread or glue. Each design element 112 may be formed out of embroidery, sequins, fabric, foam, foil, crystals, stones, rocks, jewels, glitter, paint, ink, wax, print, glass, plastic, twill, rubber, wood, paper, metal, artificial foliage and flowers, beads, buttons, pins, feathers, or even lighting or electrical effects. Further, the design element 112 may comprise live or natural elements such as flowers, succulents, or other greenery. A person of ordinary skill in the art will understand a variety of other materials can be utilized to form the design elements 112. Virtually any combination of the above-described materials may form the design elements 112 in embodiments where the textile surface 110 comprises more than one design element 112. Moreover, the design elements 112 may be placed along the textile surface 110 in a variety of arrangements to produce a desirable aesthetic result. Thus, the textile surface 110 may add aesthetic value to the ornamental member 100 and consequently, the decorative patch kit.

The backing surface 120 may be disposed opposite the textile surface 110 of the ornamental member 100 and may support the textile surface 110 by maintaining rigidity thereby allowing the textile surface 110 to remain substantially flat. The backing surface 120 may comprise a blend of one or more synthetic, semi-synthetic, or natural elements or materials. In particular, the backing surface 120 may be formed out of natural fibers, such as paper, cotton, hemp and jute; cellulose fibers, such as leaf fibers; animal fibers, such as wool; protein fibers, such as silk and feather fibers; regenerated fibers, including regenerated cellulose fibers, such as rayon and cuprammonium rayon; and regenerated protein fibers. The backing surface 120 may also include semi-synthetic fibers, such as cellulose acetate fibers and promix, nylon alamide fibers, acrylic fibers, polyolefin fibers, such as polyethylene and polypropylene fibers, polyvinyl alcohol fibers, polyvinyl chloride fibers, polyvinylidene chloride fibers, polyurethane fibers, polyoxymethylene fibers, polytetrafluoroethylene fibers, and polyimide fibers. Moreover, the backing surface 120 may be woven fabric, non-woven fabric, or a laminate thereof. The backing surface 120 may be selected from the above-mentioned materials based on desired tensile strength and thickness required to adequately support the textile surface 110.

Additionally, the backing surface 120 may comprise a thermoplastic, heat-activated adhesive material which may be capable of permanently adhering the ornamental member 100 with a desirable receiving surface. In other embodiments, the backing surface 120 may comprise a pressure-sensitive adhesive material which may be capable of temporarily adhering the ornamental member 100 with a desirable receiving surface without the use of the temporary adhesive member 200. Thus, the backing surface 120 may implement the steps outlined in blocks 504 and 505 of FIG. 2. In yet other embodiments, the backing surface 120 may comprise a drug-containing matrix containing, for instance, anti-inflammatory or analgesic properties, and may adhere directly to the wearer's skin.

In embodiments where the user desires to temporarily adhere the ornamental member 100 to a desirable receiving surface, the decorative patch kit 400 may further comprise at least one temporary adhesive member 200, as shown in a cross-sectional view provided in FIG. 4. The temporary adhesive member 200 may be defined by a first surface 202a and a second surface 202b opposing the first surface 202a. A first release liner 204 may peelably attach to the first surface 202a and a second release liner 206 may peelably attach to the second surface 202b.

The temporary adhesive member 200 may be formed into virtually any desirable shape. In certain embodiments, the shape of the temporary adhesive member 200 may be identical to the shape of the ornamental member 100. In other embodiments, the temporary adhesive member 200 may be shaped so as to overlap and extend past the boundaries of the ornamental member 100 when the two are affixed together. In such embodiments, the user may implement block 501 of FIG. 2. In particular, the ornamental member 100 may be placed along the first release liner 204 of the temporary adhesive member 200 and an outline may be traced around the ornamental member 100 on the first release liner 204. This traced outline may then be cut out of the temporary adhesive member 200 using scissors, a knife, or other convenient cutting implement and any excess material may be discarded. In yet other embodiments, the temporary adhesive member 200 may be smaller relative to the ornamental member 100.

In certain embodiments, the backing surface 120 of the ornamental member 100 may first be adhered to the first surface 202a of the temporary adhesive member 200. More specifically, the first surface 202a may be exposed by peeling off the first release liner 204. Then, the backing surface 120 may be joined to the now-exposed first surface 202a. In such embodiments, an outline may then be traced around the ornamental member 100 and this traced outline may then be cut out of the temporary adhesive member 200 and any excess material may be discarded.

The first surface 202a may be exposed by peeling off the first release liner 204 (block 502). With reference still to FIG. 4, the adhesion between the first liner 204 and the first surface 202a may be sufficiently light so that the first liner 204 may be peeled off the first surface 202a without rupturing or breaking and without leaving a deposit on the first surface 202a. The first and second release liners 204, 206 may be formed out of a release coating, such as silicone, fluorine-containing polymers, and long alkyl chain branched polymers, deposited on a substrate, which may be a supercalendared kraft paper; coated papers, such as polyethylene coated kraft paper, clay coated kraft paper, and glassine paper; non-porous, plastic films, such as polyvinylidene chloride, acrylic-based and methacrylic-based polymers, polystyrene, polycarbonate, polyimide, acetyl cellulose, regenerated cellulose, celluloid, rubber hydrohalide, vinylidene halid polymer film, or highly acetylated cellulose ester; a resin film formed from polypropylene, oriented polypropylene, cast polypropylene, polyethylene terephthalate, polybutylene terephthalate, polyester, polyethylene, polyurethane, paper, synthetic paper, polyvinyl chloride and polystyrene; synthetic resin; coated plastic film; nonwoven fabric; paper; or plastic or resin coated paper. Moreover, the first and second release liners 204, 206 may be a composite film formed out of a variety of materials such as laminate, aluminum foil, aluminum-deposited film laminated with any of the above-described materials. Furthermore, one of ordinary skill will recognize the first and second release liners 204, 206 may be formed out of other materials as well.

In some embodiments, the first release liner 204 and the second release liner 206 may be partially or fully embossed with any color or pattern, such as a diamond pattern, hexagonal pattern, wave pattern, or lattice pattern. Indeed, a person of ordinary skill in the art will understand the first and second release liners 204, 206 may be embossed with any pattern that provides sufficient grip for handling. Additionally, the first and second liners 204, 206 may be embossed with characters, arrows, symbols, or other instructive or informative markings.

The first surface 202a or the second surface 202b may be configured to affix to the backing surface 120 of the ornamental member 100 (block 503 of FIG. 2). In certain embodiments, each of the first surface 202a and the second surface 202b may be coated with a pressure-sensitive, adhesive material. In other embodiments, only one of the first or second surfaces 202a, 202b may be coated with a pressure-sensitive, adhesive material. In some embodiments, the first and second surfaces 202a, 202b may be coated with a medical-grade, latex-free adhesive material so as to allow safe and healthy application on a user's skin. In other embodiments, the first and second surfaces 202a, 202b may be coated with acrylic-based adhesive, synthetic rubber-based adhesive, natural rubber-based adhesive, polyvinyl ether, polyacrylate copolymers, or a combination thereof.

Once affixed to the backing surface 120 of the ornamental member 100, the second surface 202b of the temporary adhesive member 200 may be exposed by peeling off the second release liner 206 (block 504 of FIG. 2). The adhesion between the second liner 206 and the second surface 202b may be sufficiently light so that the second liner 206 may be peeled off the second surface 202b without rupturing or breaking and without leaving a deposit on the second surface 202b.

As seen in the above FIGS., the first and second release liners 204, 206 may be defined each as a single sheet and may maintain and protect the adhesive properties of the first and second surfaces 202a, 202b. In some embodiments, and as shown in FIG. 5, the first release liner 204 may further comprise two sheets, that is, a left sheet 205a and a right sheet 205b, each covering a respective half of the first surface 202a. In such embodiments, the left sheet 205a and/or the right sheet 205b may each comprise a tab portion, which, in turn, may facilitate removal of the left or right sheet 205a, 205b, as the case may be, from the first surface 202a. Specifically, the user may grip the tab portion to peel off the left or right sheet 205a, 205b from the first surface 202a. Similarly, the second liner 206 may further comprise two sheets, that is, a left sheet 207a and a right sheet 207b, each covering a respective half of the second surface 202b. As before, the left sheet 207a and/or the right sheet 207b may comprise a tab portion, which, in turn, may facilitate removal of the left or right sheet 207a, 207b, as the case may be, from the second surface 202b. Again, the user may grip the tab portion to peel off the left or right sheet, 207a, 207b from the second surface 202b. In certain embodiments, the first and second release liners 204, 206 may comprise greater or fewer sheets. In alternative embodiments, the first release liner 204 may comprise a single sheet while the second release liner 206 comprises more than one sheet, and vice versa.

Once the second surface 202b has been exposed, the ornamental member 100 may be adhered to any desirable receiving surface. The receiving surface may comprise skin, wood, plastic, glass, metal, metal alloys, fabric, mixed media surfaces, or any other substantially flat surface adapted to receiving adhesive. Further, the receiving surface may be capable of supporting the weight of the ornamental member 100.

It should be understood that, in some embodiments, the first surface 202a may attach to the backing surface 120 while the second surface 202b may attach to the desirable receiving surface. Meanwhile, in other embodiments, the second surface 202b may attach to the backing surface 120 while the first surface 202a may attach to the desirable receiving surface.

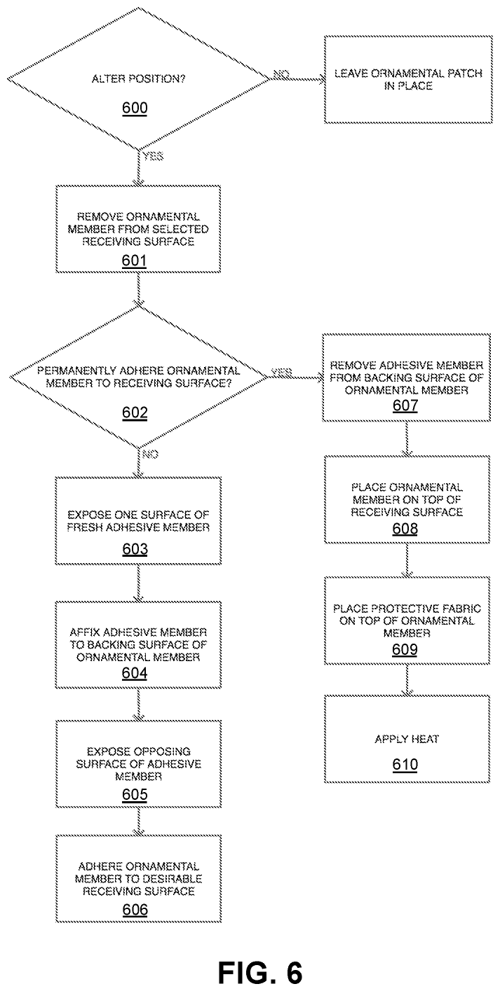

In some embodiments, and as shown in the flowchart in FIG. 6, the position and location of the ornamental member may later be altered. This method includes the steps of: removing the ornamental member from the receiving surface to which it has been adhered (block 601) and then either permanently adhering or again, temporarily adhering the ornamental member to the same or a different desirable receiving surface (block 602). To temporarily re-adhere the ornamental member to a receiving surface, one surface of a fresh adhesive member may be exposed (block 603), the adhesive member may be affixed to the backing surface of the ornamental member (block 604), the opposing surface of the adhesive member may be exposed (block 605), and finally, the ornamental member may be adhered to the same or a different desirable receiving surface (block 606). To permanently adhere the ornamental member to a receiving surface, the prior temporary adhesive member may be removed from the ornamental member thereby exposing the backing surface (block 607), the ornamental member may be placed on top of a desirable receiving surface (block 608), a protective fabric may be placed on top of the ornamental member (block 609), and finally, heat may be applied (block 610).

In certain embodiments of the decorative patch kit 400 of FIG. 1, more than one temporary adhesive member 200 may be provided. In such embodiments, the ornamental member may first be removed from the receiving surface upon which it has been adhered ((block 601). As shown in FIG. 8, if the user desires to then temporarily adhere the ornamental member to the same or a different receiving surface, a first surface of the temporary adhesive member may first be exposed by peeling off one or more release liners (block 603). Once exposed, the backing surface of the ornamental member may be affixed to the exposed surface of the temporary adhesive member (block 604). One or more release liners may then be peeled off a second surface of the temporary adhesive member, exposing the second surface (block 605). The ornamental member may then adhere to the same or a different receiving surface (block 606).

In embodiments where the user desires to alter the position of the already-placed ornamental patch and then permanently adhere the ornamental patch to the same or a different receiving surface, the user may first remove the ornamental member from the previous receiving surface (block 601). In some embodiments, the temporary adhesive member may remain adhered to the selected receiving surface while the ornamental member may be removed therefrom. In other embodiments, the temporary adhesive member may remain adhered to the backing surface of the ornamental member once the ornamental member is removed from the receiving surface. In such embodiments, the temporary adhesive member may be removed from the ornamental member by, for example, peeling, rubbing, scraping, soaking, chiseling, or scrubbing (block 607). In other embodiments, the temporary adhesive member may remain adhered to the ornamental member.

Once the temporary adhesive member has been removed from the backing surface of the ornamental member (or not, as desired), the backing surface of the ornamental member may be placed on a heat-resistant receiving surface (block 608). Next, a protective fabric may be placed on top of the ornamental member in order to protect the textile surface thereof (block 609). The protective fabric may protect and maintain the textile surface and may be formed out of any material capable of withstanding heat. For instance, the protective fabric may comprise cotton, cotton-blend, terry cloth, denim, or linen. Once the protective fabric has been desirably placed, a heat source may then supply heat to allow the ornamental member to permanently adhere to the selected receiving surface (block 610). In some embodiments, the heat source may be an iron or other convenient heating implement. The heat source may supply heat for thirty to forty-five seconds. In other embodiments, the heat source may supply heat for more time or less time so as to allow sufficient adhesion of the ornamental member to the receiving surface. Once the ornamental member has been permanently adhered to the receiving surface, the protective fabric may then be removed.

In certain embodiments, the ornamental member and selected receiving surface may then be allowed to cool so as to allow adhesion of the ornamental member to the receiving surface. A fan or other convenient cooling means may be used to expedite the cooling of the ornamental member and the receiving surface. Once the ornamental member and receiving surface have cooled, the receiving surface may be turned over and laid flat on top of a stable surface such that the ornamental member may then be positioned beneath the receiving surface. In such embodiments, the receiving surface may serve the same purpose as the protective fabric before, that is, to protect the textile surface of the ornamental member from damage due to heat. Once the receiving surface has been laid flat on a stable surface, the heat source may then supply heat to the receiving surface. In certain embodiments, the heat source may supply heat to the receiving surface for thirty to forty-five seconds. In other embodiments, the heat source may supply heat for more time or less time. The ornamental member and the receiving surface may then be allowed to cool and solidify again.

Other steps may be practiced to provide a decorative patch either temporarily or permanently adhered to a desirable receiving surface. Additional steps may include first cleaning the receiving surface to ensure it is free of dirt, lint, oil, and other contaminants and drying the receiving surface to remove any excess moisture. Further steps may include gently lifting the edges of the ornamental member to confirm the adequacy of adhesion to the receiving surface and reapplying heat from the heat source to ensure such adhesion. Moreover, the ornamental member may be cleaned as desired.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

### CONCLUSIONS, RAMIFICATIONS, AND SCOPE

While certain embodiments of the invention have been illustrated and described, various modifications are contemplated and can be made without departing from the spirit and scope of the invention. Accordingly, it is intended that the invention not be limited, except as by the appended claim(s).

The teachings disclosed herein may be applied to other systems, and may not necessarily be limited to any described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions and concepts of the various references described above to provide yet further embodiments of the invention.

Particular terminology used when describing certain features or aspects of the invention should not be taken to imply that the terminology is being refined herein to be restricted to any specific characteristics, features, or aspects of the decorative patch kit and method with which that terminology is associated. In general, the terms used in the following claims should not be constructed to limit the decorative patch kit and method to the specific embodiments disclosed in the specification unless the above description section explicitly define such terms. Accordingly, the actual scope encompasses not only the disclosed embodiments, but also all equivalent ways of practicing or implementing the disclosed system, method and apparatus. The above description of embodiments of the decorative patch kit and method is not intended to be exhaustive or limited to the precise form disclosed above or to a particular field of usage.

While specific embodiments of, and examples for, the method, system, and apparatus are described above for illustrative purposes, various equivalent modifications are possible for which those skilled in the relevant art will recognize.

While certain aspects of the method and system disclosed are presented below in particular claim forms, various aspects of the method, system, and apparatus are contemplated in any number of claim forms. Thus, the inventor reserves the right to add additional claims after filing the application to pursue such additional claim forms for other aspects of the decorative patch kit and method.

What is claimed is:

1. A decorative patch kit comprising:
an ornamental member, defined by a textile surface and a backing surface; and
at least one temporary adhesive member, defined by a first surface and a second surface.

2. The decorative patch kit of claim 1, wherein the textile surface further comprises one or more decorative elements.

3. The decorative patch kit of claim 2, wherein the one or more decorative elements comprises embroidery.

4. The decorative patch kit of claim 2, wherein the one or more decorative elements comprises sequins.

5. The decorative patch kit of claim 1, wherein the first surface and the second surface of the temporary adhesive member are coated with a medical-grade adhesive material.

6. The decorative patch kit of claim 1, wherein the temporary adhesive member further comprises
a first release liner peelably attached to the first surface; and
a second release liner peelably attached to the second surface.

7. The decorative patch kit of claim 6, wherein the first release liner is defined as a single sheet and the second release liner is defined as a single sheet.

8. The decorative patch kit of claim 6, wherein the first release liner is defined as more than one sheet and the second release liner is defined as more than one sheet.

9. A decorative patch kit comprising
an ornamental member, defined by
a textile surface and
a backing surface coated with thermoplastic, heat-activated adhesive material; and
at least one temporary adhesive member.

10. The decorative patch kit of claim 9, wherein the textile surface further comprises one or more decorative elements.

11. The decorative patch kit of claim 10, wherein the one or more decorative elements comprises embroidery.

12. The decorative patch kit of claim 10, wherein the one or more decorative elements comprises sequins.

13. The decorative patch kit of claim 9, wherein the first surface and the second surface of the temporary adhesive member are coated with a medical-grade adhesive material.

14. The decorative patch kit of claim 9, wherein the temporary adhesive member further comprises
a first release liner peelably attached to the first surface; and
a second release liner peelably attached to the second surface.

15. The decorative patch kit of claim 14, wherein the first release liner is defined as a single sheet and the second release liner is defined as a single sheet.

16. The decorative patch kit of claim 14, wherein the first release liner is defined as more than one sheet and the second release liner is defined as more than one sheet.

17. A method of temporarily and permanently applying a decorative patch kit to a desirable receiving surface, comprising:
providing a decorative patch kit comprising
an ornamental member, defined by a textile surface and a backing surface, the backing surface being coated with a thermoplastic, heat-activated adhesive material; and
a temporary adhesive member, defined by a first surface and a second surface, each of the first surface and second surface coated with pressure-sensitive adhesive;
exposing the first surface of the temporary adhesive member;
affixing the first surface of the temporary adhesive member to the backing surface of the ornamental member;
exposing the second surface of the temporary adhesive member;
adhering the ornamental member to the desirable receiving surface;
removing the temporary patch assembly from the desirable receiving surface;
removing the temporary adhesive member from the ornamental member;
placing the backing surface of the ornamental member along the same or a different desirable receiving surface;
placing a protective fabric on top of the ornamental member;
finally applying heat on top of the protective fabric.
